(19) United States
(12) Patent Application Publication
(10) Pub. No.: US 2007/0108680 A1
(43) Pub. Date: May 17, 2007

(54) Spring seal

(76) Inventor: Robert Janian, Encino, CA (US)

Correspondence Address: CISLO & THOMAS, LLP, 233 WILSHIRE BLVD, SUITE 900, SANTA MONICA, CA, 90401-1211, US

(21) Appl. No.: 11/649,402

(22) Filed: Jan. 3, 2007

Related U.S. Application Data
(63) Continuation-in-part of application No. 10/853,852, filed on May 24, 2004, now Pat. No. 7,159,857.

(51) Int. Cl. F16F 1/20

(52) U.S. Cl. 267/164

(57) ABSTRACT

A spring seal includes a first substantially flat spring strip element having a plurality of slanted arms and associated notches, and a second substantially flat spring strip element having a plurality of slanted arms and associated notches oriented oppositely to the slanted arms and notches of the first substantially flat spring strip element. The first and second spring strip elements are superimposed onto each other with their oppositely oriented slanted arms forming a substantially criss-cross configuration. The criss-crossed spring arms are bent at each end and configured to define a longitudinal axis. The bent arms are folded about the longitudinal axis to form a resilient seal of enhanced strength and durability suitable for insertion into a mechanical seal jacket.

### CROSS-REFERENCE TO RELATED APPLICATIONS

This patent application is a continuation-in-part of pending utility patent application Ser. No. 10/853,852, filed May 24, 2004, entitled “Multi Spring Ring,” published on Feb. 16, 2006 under Pub. No. US 2006/0033251 A1, which is incorporated herein in its entirety by reference.

### COPYRIGHT NOTICE

Portions of the disclosure of this patent document may contain material that is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND

Some mechanical sealing devices contain a deformable cover or jacket element typically made of elastomeric and or Teflon materials and a metallic resilient spring energizer which is readily inserted into the jacket and locked in place. A number of different configurations of mechanical spring seals are known, as disclosed, for example, in my prior U.S. Pat. Nos. 4,133,542 and 4,508,356. These types of seals are used in a variety of applications which require different types of spring energizers. Typically, all existing jacket elements are manufactured for only one specific type of energizer and if one needs to change any of the springs one would need to manufacture a completely new jacket or cover which increases manufacturing and operational costs. Also, these types of seals are increasingly being used in a variety of applications under consistently changing environments where one type of expander cannot perform as well as another when working conditions change at which one type of internal spring element has to be replaced with another type.

It would be desirable to simply replace one spring element with another on site without having to manufacture a new jacket or cover, as commonly practiced.

### SUMMARY

Some embodiments disclosed herein are generally directed to a resilient spring and an associated spring seal.

In accordance with one aspect of the invention, the resilient spring comprises a first substantially flat spring strip element including a plurality of slanted arms and associated notches, and a second substantially flat spring strip element including a plurality of slanted arms and associated notches oriented oppositely to the slanted arms and notches of the first substantially flat spring strip element. The first and second spring strip elements are superimposed onto each other in a substantially lattice configuration. The lattice configuration enhances the overall spring resiliency, strength and durability.

In accordance with another aspect of the invention, the resilient spring comprises a first substantially flat spring strip element including a plurality of slanted arms and associated notches, and a second substantially flat spring strip element including a plurality of slanted arms and associated notches oriented oppositely to the slanted arms and notches of the first substantially flat spring strip element. The first and second spring strip elements are superimposed onto each other with their respective oppositely oriented slanted arms forming a substantially criss-cross configuration. The criss-crossed spring arms are bent at each end to enhance the overall spring resiliency, strength and durability.

In accordance with still another aspect of the invention, the spring seal comprises a first substantially flat spring strip element having a plurality of slanted arms and associated notches, and a second substantially flat spring strip element having a plurality of slanted arms and associated notches oriented oppositely to the slanted arms and notches of the first substantially flat spring strip element. The first and second spring strip elements are superimposed onto each other with their oppositely oriented slanted arms forming a substantially criss-cross configuration. The criss-crossed spring arms are bent at each end and configured to define a longitudinal axis. The bent arms are folded about the longitudinal axis to form a resilient seal of enhanced strength and durability suitable for insertion into a mechanical seal jacket.

In accordance with yet another aspect of the invention, the spring seal comprises a substantially flat spring strip element including a plurality of slanted arms and associated notches. The slanted arms are bent at opposite ends and configured to define a longitudinal axis. The bent arms are folded about the longitudinal axis to form a resilient seal of enhanced strength and durability suitable for insertion into a mechanical seal jacket.

These and other aspects of the invention will become apparent from a review of the accompanying drawings and the following detailed description of the invention.

### BRIEF DESCRIPTION OF THE DRAWINGS

The invention is generally shown by way of reference to the accompanying drawings in which:

FIG. 1 is a cross-sectional view of a typical mechanical spring seal jacket;.

FIG. 2 is a plan view of a flat spring strip element configured in accordance with one exemplary embodiment of the present invention;

FIG. 3 is a front elevation of a spring formed in accordance with another exemplary embodiment of the present invention;

FIG. 4 is a cross-sectional view of a spring seal formed in accordance with yet another exemplary embodiment of the present invention;

FIG. 5 is a cross-sectional spring seal assembly view showing the seal jacket of FIG. 1 containing a typical spring element of canted coil;

FIG. 6 is a cross-sectional spring seal assembly view showing a typical flat ribbon coil spring fitted inside the seal jacket of FIG. 1;

FIG. 7 is a cross-sectional spring seal assembly view showing a typical modified “C” spring fitted inside the seal jacket of FIG. 1;

FIG. 8 is a cross-sectional spring seal assembly view showing a typical straight cantilever U/V type spring fitted inside the seal jacket of FIG. 1;

FIG. 9 is a cross-sectional spring seal assembly view showing a typical elastomeric O-ring inserted inside the seal jacket of FIG. 1;

FIG. 10 is a cross-sectional view showing a spring seal assembly constructed in accordance with the present invention;

FIG. 11 is a plan view of a flat spring formed in accordance with an alternative embodiment of the present invention;

FIG. 12 is a front elevation of a spring formed in accordance with another alternative embodiment of the present invention;

FIG. 13 is a cross-sectional view of an enhanced spring seal formed in accordance with still another alternative embodiment of the present invention;

FIG. 14 is a cross-sectional view showing another spring seal assembly constructed in accordance with the present invention; and

FIG. 15 is a perspective view of a spring seal formed in accordance with still another exemplary embodiment of the present invention.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the invention.

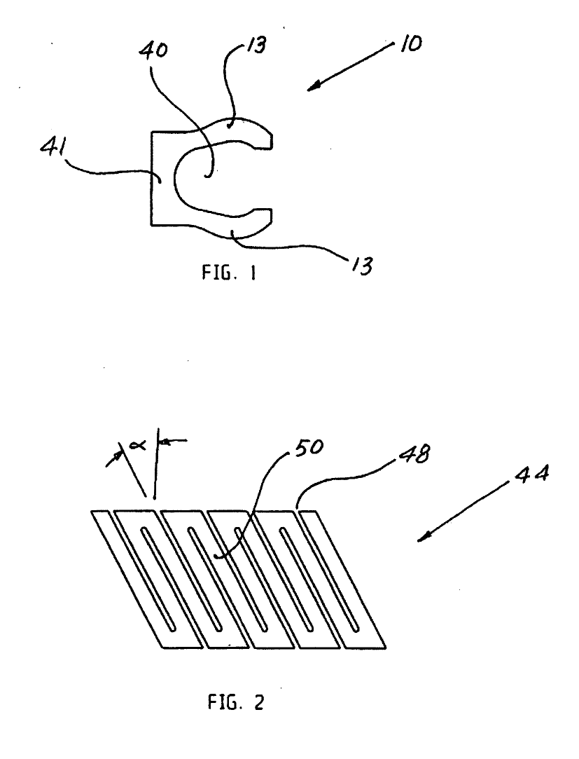

Some embodiments of the invention will be described in detail with reference to the related drawings of FIGS. 1-15. Additional embodiments, features and/or advantages of the invention will become apparent from the ensuing description or may be learned by practicing the invention. In the figures, the drawings are not to scale with like numerals referring to like features throughout both the drawings and the description.

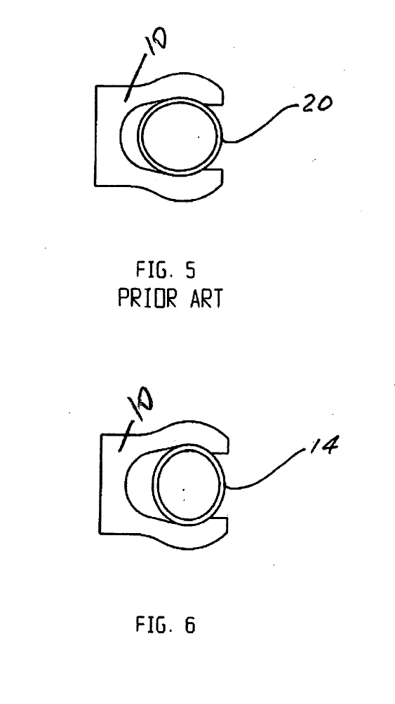

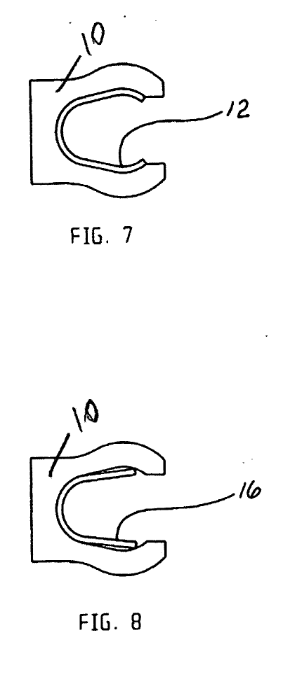

FIG. 1 is a cross-sectional view of a typical mechanical spring seal jacket or cover 10 having a seal cavity 40, heel 41 and sealing lips 13. Jacket 10 may be made of typical sealing materials such as Nylon or Teflon. Seal cavity 40 may receive a typical canted coil spring 20 (FIG. 5), a typical flat ribbon coil spring 14 (FIG. 6), a typical modified “C” shaped spring 12 (FIG. 7), a typical straight cantilever U/V type spring 16 (FIG. 8) or a typical elastomeric O-ring 21 (FIG. 9).

FIG. 2 is a plan view of a flat spring strip element 44 configured in accordance with one exemplary embodiment of the present invention. Spring element 44 may be fabricated from resilient metal sold under the trademark Elgiloy™ or the like, with a plurality of slanted or angled (α) notches 48 and arms 50 with angle α (alpha) being anywhere between 5° and 45°. Notch angle α may be formed between a vertical axis of the plane defined by flat spring element 44 and the inner wall of a notch, as schematically shown in FIG. 2. Metal strips suitable for fabricating the spring element of the present invention may be obtained from Elgiloy Specialty Metals of Elgin, Ill. or its distributors. Other suitable material(s) may be utilized as needed.

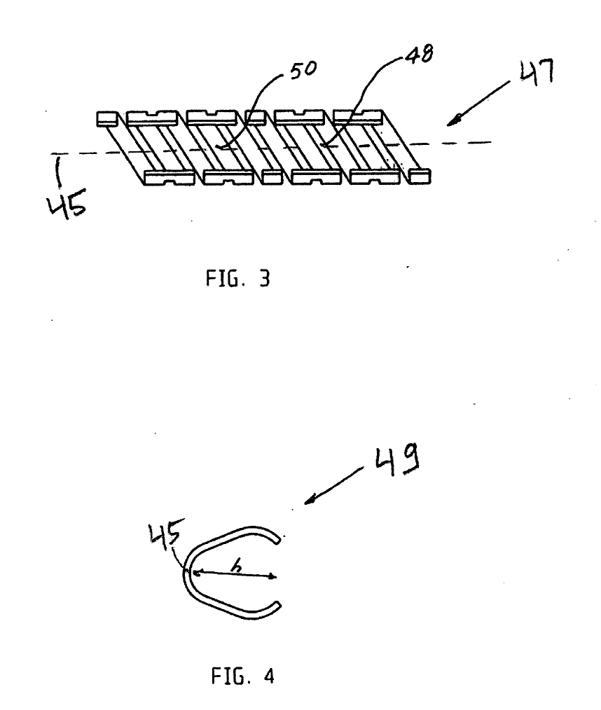

FIG. 3 is a front elevation of a spring 47 which is formed by bending the slanted arm ends of flat spring strip element 44 in accordance with another exemplary embodiment of the present invention. With this slanted configuration the length of spring arm 50 is increased relative to conventional spring seals which have a vertical spring arm configuration. A person skilled in the art would readily recognize that the increase in spring arm length made possible by the slanted configuration of the present invention does not affect the spring height (h) (FIG. 4) and overall seal assembly length thereby achieving enhanced resiliency in overall seal performance.

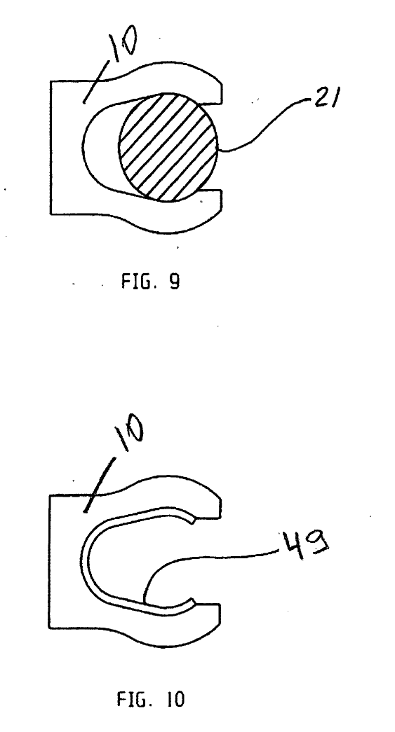

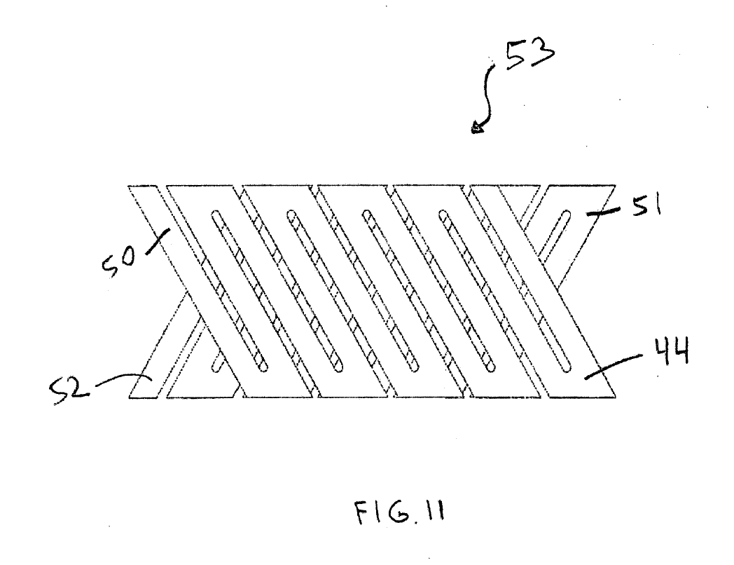

FIG. 4 is a cross-sectional view of a spring seal 49 which is formed by folding spring 47 about its longitudinal axis 45 (FIGS. 3-4) in accordance with yet another exemplary embodiment of the present invention. Spring seal 49 has a seal height (h) (FIG. 4) and may be adapted to be fitted inside a conventional seal jacket, such as jacket 10, as schematically illustrated in reference to FIG. 10. In this regard, one should not confuse the novel spring seal assembly of FIG. 10 with the conventional spring seal assembly of FIG. 7. Particularly, arms 50 of spring seal 49 of FIG. 10 in reality are longer (because of their slanted configuration), while the spring arms of modified “C” shaped spring 12 of FIG. 7 are shorter.

FIG. 5 is a cross-sectional spring seal assembly view showing seal jacket 10 containing a typical spring element of canted coil 20. FIG. 6 is another cross-sectional spring seal assembly view showing a typical flat ribbon coil spring 14 fitted inside seal jacket 10. FIG. 7 is yet another cross-sectional spring seal assembly view of a typical modified “C” shaped spring 12 fitted inside seal jacket 10. FIG. 8 is still another cross-sectional spring seal assembly view of a typical straight cantilever U/V type spring 16 fitted inside seal jacket 10. FIG. 9 is a further cross-sectional spring seal assembly view of a typical elastomeric O-ring 21 inserted inside seal jacket 10.

The present invention may be effectively utilized in seal glands fabricated in industry particularly in aerospace where smaller and lighter more efficient units are needed. The spring element of the present invention may be used with various types of conventional seal jackets, such as jacket 10 (FIG. 1). These jackets may be made of materials than Nylon or Teflon. These materials are subjected to constant pressure and fatigue as forces are being exerted on sealing lips 13 of jacket 10 (FIG. 1). Even though these jacket materials may become hardened and brittle as a result of continuous operation, the spring element of the present invention would keep its resiliency so that seal assembly of FIG. 10 could maintain its overall performance.

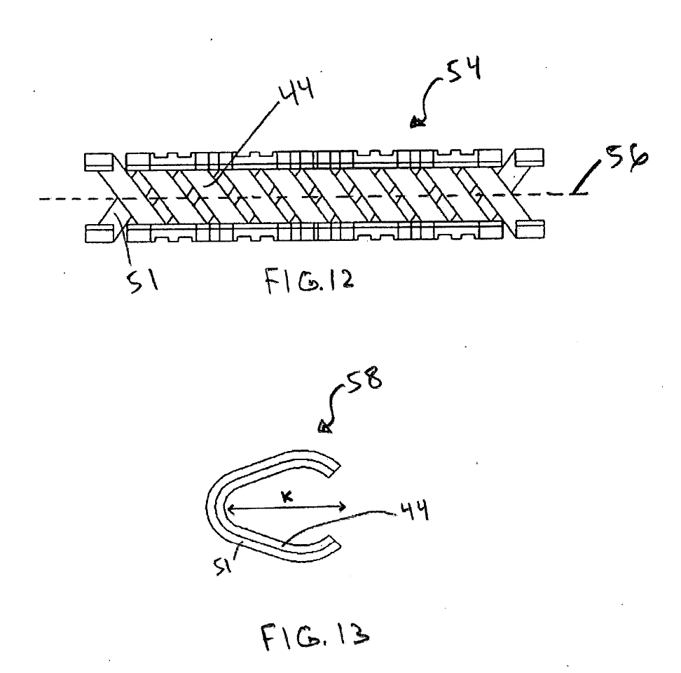

FIG. 11 is a plan view of a resilient flat spring 53 with a substantially criss-cross or lattice configuration formed by superimposing flat spring strip element 44 of FIG. 2 onto oppositely oriented flat spring strip element 51 (FIG. 11). Specifically, flat spring strip element 51 has oppositely oriented notches and seal arms 52 (FIG. 11) relative to the notches and seal arms 50 of spring strip element 44 (FIGS. 2, 11) in accordance with an alternative embodiment of the present invention. The criss-cross or lattice configuration of this embodiment enhances the overall resiliency, strength and durability of spring 53. Flat spring strip element 51 (FIG. 11) may also be made from resilient metal sold under the trademark Elgiloy™ and/or other suitable material(s), as needed.

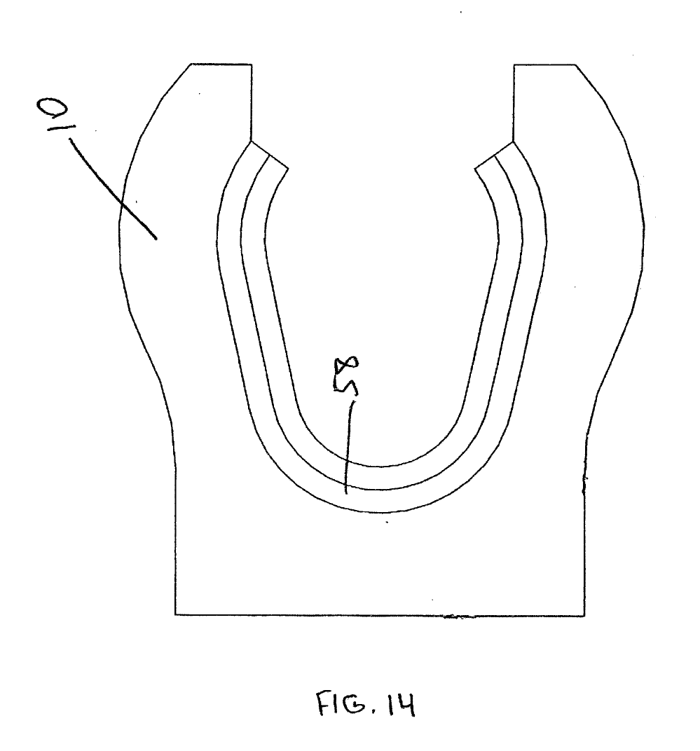

FIG. 12 is a front elevation of a spring 54 formed by bending the slanted and criss-crossed seal arm ends of resilient flat spring 53 of FIG. 11 in accordance with another alternative embodiment of the present invention.

FIG. 13 is a cross-sectional view of an enhanced spring seal 58 which is formed by folding spring 54 about its longitudinal axis 56 (FIG. 12) in accordance with still another alternative embodiment of the present invention. While FIG. 13 schematically shows the two superimposed spring strips (44, 51) being folded generally toward the reader, a person skilled in the art would appreciate that folding in the opposite direction is also possible. Other folding configurations may be employed, provided such other configurations do not depart from the intended purpose of the present invention.

Enhanced spring seal 58 has a seal height (k) (FIG. 13) and may be adapted to be fitted inside a conventional seal jacket, such as jacket 10, as schematically illustrated in reference to FIG. 14. In this case, seal height k (FIG. 13) would be less than seal height h of FIG. 4. The spring seal assembly of FIG. 14 provides enhanced spring seal durability and resiliency during a variety of severe working environment conditions.

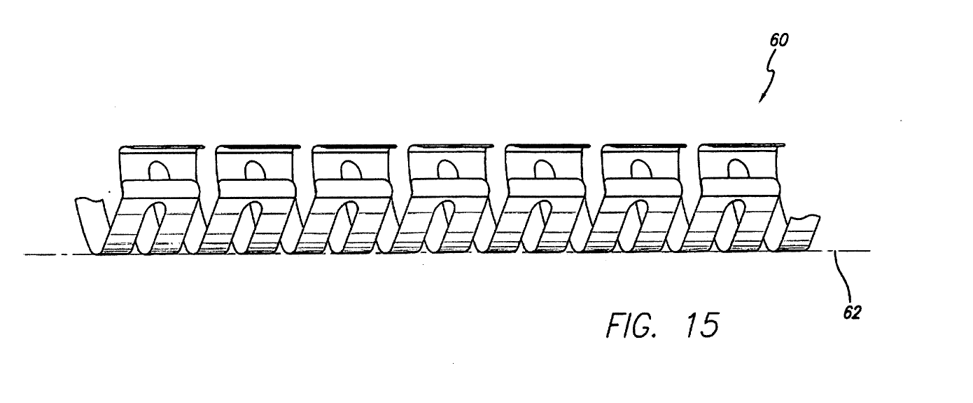

FIG. 15 is a perspective view of a spring seal 60 formed in accordance with still another exemplary embodiment of the present invention. Spring seal 60 has a longitudinal axis 62 and arms and notches oriented similar to the arms (52) and notches of spring strip 51 (FIG. 11).

A person skilled in the art would appreciate that embodiments described hereinabove are merely illustrative of the general principles of the present invention. Other modifications or variations may be employed that are within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed:

1. A resilient spring, comprising:
a first substantially flat spring strip element including a plurality of slanted arms and associated notches;
a second substantially flat spring strip element including a plurality of slanted arms and associated notches oriented oppositely to the slanted arms and notches of said first substantially flat spring strip element,
said first and second spring strip elements being superimposed onto each other in a substantially lattice configuration, said lattice configuration enhancing the overall spring resiliency, strength and durability.

2. The resilient spring of claim 1, wherein each of said first and second spring strip elements is made of resilient metal.

3. A resilient spring, comprising:
a first substantially flat spring strip element including a plurality of slanted arms and associated notches;
a second substantially flat spring strip element including a plurality of slanted arms and associated notches oriented oppositely to the slanted arms and notches of said first substantially flat spring strip element,
said first and second spring strip elements being superimposed onto each other with their respective oppositely oriented slanted arms forming a substantially criss-cross configuration, said criss-crossed spring arms being bent at each end to enhance the overall spring resiliency, strength and durability.

4. The resilient spring of claim 3, wherein each of said first and second superimposed spring strip elements is made of resilient metal.

5. A spring seal, comprising:
a first substantially flat spring strip element including a plurality of slanted arms and associated notches;
a second substantially flat spring strip element including a plurality of slanted arms and associated notches oriented oppositely to the slanted arms and notches of said first substantially flat spring strip element,
said first and second spring strip elements being superimposed onto each other with their respective oppositely oriented slanted arms forming a substantially criss-cross configuration, said criss-crossed spring arms being bent at each end and configured to define a longitudinal axis, said bent arms being folded about said longitudinal axis to form a resilient seal of enhanced strength and durability suitable for insertion into a mechanical seal jacket.

6. The spring seal of claim 5, wherein each of said first and second superimposed spring strip elements is made of resilient metal.

7. The spring seal of claim 5, wherein said folded crisscrossed arms define a seal height suitable for use in conjunction with a mechanical seal jacket.

8. A spring seal comprising a substantially flat spring strip element including a plurality of slanted arms and associated notches, said slanted arms being bent at opposite ends and configured to define a longitudinal axis, said bent arms being folded about said longitudinal axis to form a resilient seal of enhanced strength and durability suitable for insertion into a mechanical seal jacket.

9. The spring seal of claim 8, wherein said folded arms define a seal height suitable for use in conjunction with a mechanical seal jacket.

10. The spring seal of claim 8, wherein said substantially flat spring strip element is made of resilient metal.

11. The spring seal of claim 8, wherein said substantially flat spring strip element defines a plane with a vertical axis.

12. The spring seal of claim 11, wherein each of said arms of said substantially flat spring strip element is slanted at an angle formed between said vertical axis and the inner wall of an associated notch.

13. The spring seal of claim 12, wherein said angle is in the range of 5° to 45°.

14. The spring of claim 1, wherein each of said first and second substantially flat spring strip elements defines a respective plane with a vertical axis.

15. The spring of claim 14, wherein each arm of said first substantially flat spring strip element is slanted at a first angle formed between said vertical axis and the inner wall of an associated notch.

16. The spring of claim 15, wherein said first angle is in the range of 5° to 45°.

17. The spring of claim 14, wherein each arm of said second substantially flat spring strip element is slanted at a second angle formed between said vertical axis and the inner wall of an associated notch.

18. The spring of claim 17, wherein said first angle is in the range of −5° to −45°.

19. The spring of claim 3, wherein each of said first and second substantially flat spring strip elements defines a respective plane with a vertical axis.

20. The spring of claim 19, wherein each arm of said first substantially flat spring strip element is slanted at a first angle formed between said vertical axis and the inner wall of an associated notch.

21. The spring of claim 20, wherein said first angle is in the range of 5° to 45°.

22. The spring of claim 19, wherein each arm of said second substantially flat spring strip element is slanted at a second angle formed between said vertical axis and the inner wall of an associated notch.

23. The spring of claim 22, wherein said first angle is in the range of −5° to −45°.
